(19) United States
(12) Patent Application Publication
(10) Pub. No.: US 2020/0205456 A1
(43) Pub. Date: Jul. 2, 2020

(54) NUTRITIONAL TABLETS AND METHODS OF MAKING THE SAME

(71) Applicant: ABBOTT LABORATORIES, Abbott Park, IL (US)

(72) Inventors: NECLA EREN, Columbus, OH (US); TIMOTHY LAPLANTE, Powell, OH (US); DOUGLAS WEARLY, Blacklick, OH (US); NALINI PATEL, Plain City, OH (US)

(73) Assignee: ABBOTT LABORATORIES, Abbott Park, IL (US)

(21) Appl. No.: 16/633,977

(22) PCT Filed: Jul. 24, 2018
(86) PCT No.: PCT/US2018/043516

§ 371 Date: Jan. 24, 2020

Related U.S. Application Data
(60) Provisional application No. 62/537,148, filed on Jul. 26, 2017.

(51) Int. Cl. A23L 33/115; A23L 33/00; A23L 33/125; A23L 33/17; A23P 10/28

(52) U.S. Cl. CPC A23L 33/115; A23L 33/40; A23V 2002/00; A23L 33/17; A23P 10/28; A23L 33/125

(57) ABSTRACT

Nutritional tablets and methods of making nutritional tablets are provided. The nutritional tablets include a compressed nutritional powder that includes protein, carbohydrate, fat, and 0.15% to 6% by weight of a flow agent based on the weight of the nutritional tablet. The nutritional tablet has a hardness of no more than 14 N and a surface polarity of greater than 30.5%.

### CROSS-REFERENCE TO RELATED APPLICATIONS

This application claims priority to and the benefit of U.S. Provisional Patent Application No. 62/537,148, filed Jul. 26, 2017, the entire content of which is incorporated by reference herein.

### FIELD

This disclosure relates to nutritional tablets, particularly infant formula tablets, used to produce liquid nutritional compositions when dissolved in a liquid such as water.

### BACKGROUND

A variety of nutritional formulas are commercially available today. These formulas typically contain a balance of proteins, carbohydrates, lipids, vitamins, and minerals tailored to the nutritional needs of the intended user, and include product forms such as ready-to-drink liquids, reconstitutable powder, nutritional bars, tablets, and the like. Among the many nutritional formulas commercially available today, infant formulas have become particularly well known and commonly used in providing a supplemental, primary, or sole source of nutrition early in life. Although ready-to-feed liquid infant formulas and powdered infant formulas are especially popular, both forms occupy more volume, and hence, require more packaging materials, than an equivalent dose in dissolvable tablet form.

Nutritional tablets are offered to consumers as a convenience in preparing liquid nutritional compositions, such as liquid infant formulas. However, convenient preparation of the liquid nutritional composition with a nutritional tablet is only possible if the nutritional tablet is able to rapidly and completely dissolve. Such nutritional tablets should also be able to withstand normal manufacturing and post-manufacturing handling without breaking or disintegrating.

### SUMMARY

The present disclosure is directed to nutritional tablets, including infant formula tablets. The present disclosure is also directed to methods of making such nutritional tablets.

In an exemplary embodiment, a nutritional tablet is provided. The nutritional tablet comprises a compressed nutritional powder. The nutritional powder includes protein, carbohydrate, fat, and 0.15% to 6% by weight of a flow agent based on the weight of the nutritional tablet. The nutritional tablet has a hardness of no more than 14 N and a surface polarity of greater than 30.5%.

In another exemplary embodiment, a method of manufacturing a nutritional tablet is provided. The method includes dryblending a flow agent into a base powder to form an intermediate powder. The base powder comprises protein, carbohydrate, and fat. The intermediate powder is compressed to form a pre-tablet. The pre-tablet is milled to form a final powder, and the final powder is compressed to form the nutritional tablet. The nutritional tablet comprises 0.15% to 6% by weight of flow agent based on the weight of the nutritional tablet. In addition, the nutritional tablet has a hardness of no more than 14 N and a surface polarity of greater than 30.5%.

In certain exemplary embodiments, the method further includes dryblending additional flow agent into the final powder prior to compressing the final powder. In certain exemplary embodiments, the nutritional tablet has a hardness of 8 N to 12 N and a surface polarity of greater than 30.5%.

### BRIEF DESCRIPTION OF THE DRAWINGS

FIG. 1 is a graph illustrating the dissolution of nutritional tablets as a function of surface energy and a linear regression line that best fits the data points, according to the Example described herein.

FIG. 2 is a graph illustrating the dissolution of nutritional tablets as a function of surface polarity and a linear regression line that best fits the data points, according to the Example described herein.

FIG. 3 is a graph illustrating the dissolution of nutritional tablets as a function of hardness and a linear regression line that best fits the data points, according to the Example described herein.

### DETAILED DESCRIPTION

The present disclosure is directed to nutritional tablets, including infant formula tablets. The tablets are dissolvable in water or another aqueous liquid, thereby forming a liquid nutritional composition, such as a liquid infant formula. The present disclosure is also directed to methods of making such nutritional tablets. While the general inventive concepts of the present disclosure may take diverse forms, various embodiments will be described herein, with the understanding that the present disclosure is to be considered merely exemplary, and the general inventive concepts are not intended to be limited to the disclosed embodiments.

### Definitions

The term “base powder” as used herein, unless otherwise specified, refers to nutritional compositions without a flow agent added. Base powders comprise at least one of protein, carbohydrate, and fat, and are suitable for enteral administration to a subject. Base powders may further comprise vitamins, minerals, and other ingredients. The base powder may represent sole, primary, or supplemental sources of nutrition for the subject.

The terms “dryblended” or “dryblending” as used herein, unless otherwise specified, refer to the mixing of dry or semi-dry components or ingredients together, or to the addition of a dry, powdered, or granulated component or ingredient to an existing powder.

The term “infant” as used herein, unless otherwise specified, refers to a human about 36 months of age or younger. The term “toddler,” as used herein, unless otherwise specified, refers to a subgroup of infants from about 12 months of age to about 36 months (3 years) of age. The term “child,” as used herein, unless otherwise specified, refers to a human about 3 years of age to about 18 years of age. The term “adult,” as used herein, unless otherwise specified, refers to a human about 18 years of age or older.

The term “infant formula” as used herein, unless otherwise specified, refers to nutritional compositions that have the proper balance of macronutrients, micro-nutrients, and calories to provide sole or supplemental nourishment for, and generally maintain or improve the health of, infants, toddlers, or both.

The terms “nutritional composition,” “nutritional product,” and “nutritional formula” as used herein, unless otherwise specified, are used interchangeably and refer to nutritional powders, solids, semi-solids, liquids, and semi-liquids that comprise protein, carbohydrate, and fat, and are suitable for enteral administration to a subject. Nutritional compositions may further comprise vitamins, minerals, and other ingredients, and represent sole, primary, or supplemental sources of nutrition.

The terms “nutritional liquid” and “liquid nutritional composition” as used herein, unless otherwise specified, are used interchangeably and refer to nutritional products in ready-to-drink liquid form, concentrated form, liquids made by reconstituting nutritional powders prior to use, and liquids made by dissolving the nutritional tablets therein prior to use.

The term “nutritional powder” as used herein, unless otherwise specified, refers to nutritional compositions in reconstitutable powder form.

The term “nutritional tablet” as used herein, unless otherwise specified, refers to a dosage element used to deliver a predetermined amount of a nutritional composition to a subject. The nutritional tablet is a compressed solid mixture comprising the nutritional composition. When immersed in water or another aqueous liquid, the nutritional tablet dissolves in the liquid in a manner that produces a ready-to-feed liquid nutritional composition.

The term “powder” as used herein, unless otherwise specified, describes a physical form of a composition, or portion thereof, comprising dry or semi-dry particles or other such particulate material.

The term “reconstitutable powder” as used herein, unless otherwise specified, refers to powders that are mixed with water or another aqueous liquid to create a liquid composition or liquid nutritional composition.

The term “unit dose” as used herein, unless otherwise specified, refers to a dose of product sufficient for providing a single serving to the subject.

### Product Form

As mentioned above, the present disclosure is directed to nutritional tablets, including infant formula tablets. The nutritional tablets of the present disclosure comprise a compressed nutritional powder comprising protein, carbohydrate, fat, and 0.15% to 6% by weight of a flow agent based on the weight of the nutritional tablet. The nutritional tablets have a hardness of no more than 14 N and a surface polarity of greater than 30.5%.

The size, shape, and weight of the nutritional tablet can vary widely and are not critical. Because a primary benefit of the nutritional tablet of the present disclosure is consumer convenience, the nutritional tablets will typically be formulated to provide a unit dose of a nutritional composition. In certain embodiments, the unit dose is a single serving of a nutritional composition. For example, when the nutritional tablet is an infant formula tablet, upon dissolution, a unit dose will provide the amount of formula that an infant typically consumes in one feeding. In certain embodiments, the manner of accomplishing this is to make one infant formula tablet equivalent to one scoop of conventional powdered infant formula (i.e., comparable serving, dissolution instructions, etc.). Thus, in such an embodiment, one infant formula tablet will typically contain about 5 to about 10 grams of infant formula and will be dissolved in about 60 milliliters (2 fluid ounces) of water. In certain of the foregoing embodiments, multiple nutritional tablets can be dissolved at one time in larger volumes of water to provide a larger serving. In accordance with certain embodiments of the present disclosure, the nutritional tablets are not limited to unit dose or single serving tablets. In certain embodiments, larger tablets can be prepared which on reconstitution provide multiple servings, for example, multiple feedings for an infant.

The unit dose nutritional tablets, including unit dose infant formula tablets, in certain embodiments, have a nutritional profile that is substantially identical to a comparable commercially available nutritional powder. Although the nutritional tablets of the present disclosure are prepared using a nutritional powder, it should be understood that commercially available nutritional powders are not always suitable for preparing a dissolvable nutritional tablet, as will be explained in more detail below.

The nutritional tablets of the present disclosure are sturdy enough to withstand handling without easily breaking or crumbling, both from the manufacturing and/or packaging perspective and from the consumer perspective. This sturdiness may be characterized by the hardness of the nutritional tablet. However, the hardness of a nutritional tablet can have an effect on the dissolution of the nutritional tablet. It was found that nutritional tablets formulated to have a hardness of no more than 14 N, for example from 8 N to 14N, are sturdy enough to withstand handling (e.g., without breaking or crumbling) while also exhibiting excellent dissolution characteristics, for example greater than 85% dissolution.

Unless otherwise indicated herein, the hardness of the nutritional tablet is determined using a hardness tester, such as a Dr. Schleuniger® Pharmatron 8M manual tablet hardness tester in the standard mode with a standard jaw geometry. In certain exemplary embodiments, the nutritional tablet has a hardness of no more than 12 N. In other exemplary embodiments, the nutritional tablet has a hardness of no more than 10 N. In still other exemplary embodiments, the nutritional tablet has a hardness of 8 N to 12 N. In yet other exemplary embodiments, the nutritional tablet has a hardness of 8 N to 10 N.

Unless otherwise indicated herein, the dissolution of the nutritional tablet is determined in accordance with the following procedure. First, 60 mL of water is added into an 8 fl. oz. bottle. The water is held at a temperature of 24° C. Next, tablet mass is measured to determine the “pre-dissolution mass,” and subsequently dropped into the bottle containing the water. The bottle is capped and sealed and a timer is started. The bottle is hand-shaken in a vertical shaking motion at a frequency of 1.27 hz and an amplitude of 20 cm for 30 seconds. The solid mass remaining is collected, dried, and weighed to determine the “post-dissolution mass.” The percent dissolution (% dissolution) is determined according to the following formula:

$$\% Dissolution = ( 1 - \frac{( Pre \text{-} Dissolution Mass - Post \text{-} Dissolution Mass )}{( Pre \text{-} Dissolution Mass )} ) \times 100 \% .$$

In addition to a hardness of no more than 14 N, it was also found that nutritional tablets formulated to have a surface polarity of greater than 30.5%, for example from 30.5% to 35%, improves the wettability and, thus, dissolution of the nutritional tablet. Unless otherwise indicated herein, the surface polarity and other thermodynamic characteristics of the nutritional tablet are determined using the well-known Washburn method and Fowkes theory. In certain exemplary embodiments, the nutritional tablet has a surface polarity of 30.5% to 35%, including from 30.5% to 33%, and also including from 30.5% to 32%.

### Flow Agent

Embodiments of the nutritional tablet disclosed herein comprise from 0.15% to 6% by weight of a flow agent based on the weight of the nutritional tablet. As briefly mentioned above, commercially available nutritional powders are not always suitable for use in preparing a dissolvable nutritional tablet. For example, commercially available nutritional powders may not have the requisite flowability necessary for processing the nutritional powder in a tablet press. The flowability of the commercially available nutritional powders may prevent the powders from moving through the tableting equipment cleanly (e.g., without clumping or caking), thereby making the equipment susceptible to clogging at openings or choke-points.

The flow agent according to the present disclosure provides the nutritional powders used in the preparation of the nutritional tablets the appropriate flowability needed for use in a tablet press. In certain embodiments, the use of the flow agent provides the nutritional powders used in the preparation of the nutritional tablets with consistent and reliable processability through the tablet press and associated processing equipment. In certain embodiments, the flow agent disclosed herein improves the flowability of commercially available nutritional powders such that the commercially available nutritional powders can be compressed into a nutritional tablet in accordance with embodiments of the present disclosure.

As discussed in greater detail below, the method of manufacturing the nutritional tablets of the present disclosure includes dryblending up to 6% by weight of a flow agent, based on the weight of the nutritional tablet, into a base powder. In certain embodiments, from 0.15% to 6% by weight of the flow agent, based on the weight of the nutritional tablet, is dryblended into the base powder, including from 0.5% to 4% by weight of the flow agent, from 0.5% to 2% by weight of the flow agent, from 0.5% to 1% by weight of the flow agent, from 1% to 6% by weight of the flow agent, from 2% to 6% by weight of the flow agent, from 4% to 6% by weight of the flow agent, and also including from 5% to 6% by weight of the flow agent based on the weight of the nutritional tablet.

The flow agent is a powder or other dry or semi-dry particulate or particulate-like material that performs one or more of the following functions to improve the flowability of the nutritional powder: 1) prevent packing of nutritional powder particles and act as a physical barrier when the nutritional powder is moving; 2) coat and smooth the edges of the nutritional powder to reduce inter-particle friction; and 3) absorb excess moisture before it is absorbed by the nutritional powder. Exemplary flow agents suitable for use in the nutritional tablets and methods disclosed herein include, but are not limited to, tricalcium phosphate, fumed silica, lactose, and combinations thereof.

Tricalcium phosphate is also known as tribasic calcium phosphate. The tricalcium phosphate may be a micronized tricalcium phosphate (also referred to herein as “micronized TCP”). Fumed silica is also known as pyrogenic silica. When the nutritional tablet is an infant formula tablet, preferably the flow agent is micronized TCP, lactose, and combinations thereof.

Suitable micronized TCP for use in the exemplary nutritional tablets and methods of the present disclosure may be characterized by the particle size. In particular, suitable micronized TCP for use in embodiments of the present disclosure has an average particle size of no more than 5 μm. Unless otherwise indicated herein, the average particle size is determined using laser diffraction. For example, the average particle size may be determined using a HELSO/KR laser diffraction sensor (Sympatec GmbH, Germany) equipped with a Class Ma He—Ne laser operating at 632.8 nm and a RODOS dry dispersion unit (Sympatec GmbH, Germany) operating with the following parameters: vibration 50-60% feed rate; b) incoming air pressure source—85-90 psi; c) primary air pressure RODOS/M—3.5 bar; d) 4 mm injector; and e) depression ˜90.

Suitable fumed silica for use in the exemplary nutritional tablets and methods of the present disclosure may be characterized by a surface area of 60 m²/g to 250 m²/g and an average aggregate size of 0.2 μm to 0.5 μm. In particular, suitable fumed silica for use in embodiments of the present disclosure has a surface area of 175 m²/g to 225 m²/g. Unless otherwise indicated herein, the surface area is determined by Brunauer-Emmett-Teller (BET) method.

Suitable lactose for use in the exemplary nutritional tablets and methods of the present disclosure include lactose monohydrate, agglomerated lactose, agglomerated anhydrous lactose, and combinations thereof. Examples of suitable lactose monohydrate include FlowLac® 100 spray-dried lactose monohydrate and Sorb® Lac® 400 milled lactose monohydrate, both available from Meggle AG (Wasserburg, Germany). An example of suitable agglomerated lactose is Tablettose® 70 agglomerated lactose available from Meggle AG (Wasserburg, Germany). An example of suitable agglomerated anhydrous lactose is SuperTab® 24AN agglomerated anhydrous lactose available from DMV-Fonterra Excipients GmbH & Co. KG (Goch, Germany).

In certain exemplary embodiments, the nutritional tablet comprises from 0.15% to 6% by weight of a flow agent, including from 0.5% to 6% by weight of a flow agent, and also including from 0.7% to 5.7% by weight of a flow agent. In certain of the foregoing embodiments, the flow agent comprises tricalcium phosphate having an average particle size of no more than 5 μm. In certain of the foregoing embodiments, the flow agent comprises tricalcium phosphate having an average particle size of no more than 5 μm and agglomerated anhydrous lactose. In certain exemplary embodiments, the nutritional tablet comprises from 0.5% to 1% by weight tricalcium phosphate having an average particle size of no more than 5 μm. In certain exemplary embodiments, the nutritional tablet comprises from 0.5% to 1% by weight tricalcium phosphate having an average particle size of no more than 5 μm and from 4.5% to 5.5% by weight of agglomerated anhydrous lactose.

### Base Powder

The method of manufacturing the nutritional tablets of the present disclosure includes dryblending a flow agent into a base powder. As a powder or other dry or semi-dry particulate-like material, the base powder will comprise particles or other particulate-like matter. In accordance with embodiments disclosed herein, the base powder is a nutritional composition prior to being mixed with a flow agent powder. In certain embodiments, the base powder is a commercially available nutritional powder. In other words, the base powder alone may represent a sole, primary, or supplemental source of nutrition for a subject (i.e., infant, toddler, child, or adult).

In the exemplary embodiments disclosed herein, the base powder comprises protein, carbohydrate, and fat. In certain exemplary embodiments, the base powder further comprises vitamins and minerals, and may also include other ingredients. The base powder may be prepared in accordance with any of a variety of known or otherwise effective methods of preparing a nutritional powder. Such methods typically include preparing an aqueous slurry comprising protein, carbohydrate, and fat, which may be accomplished in a batchwise manner or continuously (e.g., via an extruder). Then, the slurry optionally may be concentrated to a desired solids content. The base powder may be formed by spray drying or freeze drying the resulting slurry into a spray- or freeze-dried powder. Alternatively or in addition, the resulting slurry may be dried or further concentrated, and the resulting high-solids product may be ground or milled into a powder. Because the particles of the base powder are formed from a slurry comprising all but the dryblended flow agent, the particles of the base powder have a significantly different profile and constituency than the particles of the flow agent, e.g., for a base powder containing protein, carbohydrate, and fat, among other things, the corresponding base powder particle will contain protein, carbohydrate, and fat, among other things.

Macronutrients

Base powders according to the present disclosure comprise protein, carbohydrate, and fat. Generally, any source of protein, carbohydrate, and fat that is suitable for use in nutritional products is also suitable for use herein, provided that such macronutrients are also compatible with the essential elements of the nutritional compositions as defined herein.

Although total concentrations or amounts of protein, carbohydrate, and fat may vary depending upon the nutritional needs of the subject, such concentrations or amounts most typically fall within one of the following embodied ranges, inclusive of any other essential protein, carbohydrate, and fat ingredients as described herein.

In certain embodiments, when the nutritional tablet is formulated as an infant formula tablet, the protein component is typically present in an amount of from 5% to 35% by weight of the nutritional tablet (i.e., the infant formula tablet), including from 10% to 30%, from 10% to 25%, from 15% to 25%, from 20% to 30%, from 15% to 20%, and also including from 10% to 16% by weight of the nutritional tablet (i.e., the infant formula tablet). The carbohydrate component is typically present in an amount of from 40% to 75% by weight of the nutritional tablet (i.e., the infant formula tablet), including from 45% to 75%, from 45% to 70%, from 50% to 70%, from 50% to 65%, from 50% to 60%, from 60% to 75%, from 55% to 65%, and also including from 65% to 70% by weight of the nutritional tablet (i.e., the infant formula tablet). The fat component is typically present in an amount of from 10% to 40% by weight of the nutritional tablet (i.e., the infant formula tablet), including from 15% to 40%, from 20% to 35%, from 20% to 30%, from 25% to 35%, and also including from 25% to 30% by weight of the nutritional tablet (i.e., the infant formula tablet).

In certain embodiments, when the nutritional tablet is formulated as a pediatric formula tablet, i.e., a formula intended for infants, toddlers, and/or children, the protein component is typically present in an amount of from 5% to 30% by weight of the nutritional tablet (i.e., the pediatric formula tablet), including from 10% to 25%, from 10% to 20%, from 10% to 15%, from 15% to 20%, and also including from 12% to 20% by weight of the nutritional tablet (i.e., the pediatric formula tablet). The carbohydrate component is typically present in an amount of from 40% to 75% by weight of the nutritional tablet (i.e., the pediatric formula tablet), including from 45% to 70%, from 50% to 70%, from 55% to 70%, and also including from 55% to 65% by weight of the nutritional tablet (i.e., the pediatric formula tablet). The fat component is typically present in an amount of from 10% to 25% by weight of the nutritional tablet (i.e., the pediatric formula tablet), including from 12% to 20%, and also including from 15% to 20% by weight of the nutritional tablet (i.e., the pediatric formula tablet).

Additional suitable ranges for proteins, carbohydrates, and fats in those embodiments where the nutritional tablet is formulated as an infant formula or a pediatric formula, based on the percentage of total calories of the nutritional tablet, are set forth in Table 1.

TABLE 1

| | Embodiment A | Embodiment B | Embodiment C |
|---|---|---|---|
| Macronutrient | (% Calories) | (% Calories) | (% Calories) |
| Protein | 2-75 | 5-50 | 7-40 |
| Carbohydrate | 1-85 | 30-75 | 35-65 |
| Fat | 5-70 | 20-60 | 25-50 |

Note:
Each numerical value in the table is preceded by the term “about.”

In certain embodiments, when the nutritional tablet is formulated as an adult nutritional product (i.e., adult formula tablet), the protein component is typically present in an amount of from 5% to 35% by weight of the nutritional tablet (i.e., the adult formula tablet), including from 10% to 30%, from 10% to 20%, from 15% to 20%, and including from 20% to 30% by weight of the nutritional tablet (i.e., the adult formula tablet). The carbohydrate component is typically present in an amount of from 40% to 80% by weight of the nutritional tablet (i.e., the adult formula tablet), including from 50% to 75%, from 50% to 65%, from 55% to 70%, and also including from 60% to 75% by weight of the nutritional tablet (i.e., the adult formula tablet). The fat component is typically present in an amount of from 0.5% to 20% by weight of the nutritional tablet (i.e., the adult formula tablet), including from 1% to 15%, from 1% to 10%, from 1% to 5%, from 5% to 20%, from 10% to 20%, and also including from 15% to 20% by weight of the nutritional tablet (i.e., the adult formula tablet).

Additional suitable ranges for proteins, carbohydrates, and fats in those embodiments where the nutritional table is formulated as an adult nutritional product, based on the percentage of total calories of the nutritional powder, are set forth in Table 2.

TABLE 2

| | Embodiment D | Embodiment E | Embodiment F |
|---|---|---|---|
| Macronutrient | (% Calories) | (% Calories) | (% Calories) |
| Protein | 1-98 | 5-80 | 15-55 |
| Carbohydrate | 1-98 | 0-75 | 20-50 |
| Fat | 1-98 | 20-70 | 25-40 |

Note:
Each numerical value in the table is preceded by the term “about.”

Generally, any source of protein may be used so long as it is suitable for oral nutritional compositions and is otherwise compatible with any other selected ingredients or features of the base powder used to prepare the nutritional tablet. Non-limiting examples of suitable proteins (and sources thereof) for use in the base powders described herein include, but are not limited to, intact, hydrolyzed, or partially hydrolyzed protein, which may be derived from any known or otherwise suitable source such as milk (e.g., casein, whey), animal (e.g., meat, fish), cereal (e.g., rice, corn, wheat), vegetable (e.g., soy, pea, potato, bean), and combinations thereof. The protein may also include a mixture of amino acids (often described as free amino acids) known for use in nutritional products or a combination of such amino acids with the intact, hydrolyzed, or partially hydrolyzed proteins described herein. The amino acids may be naturally occurring or synthetic amino acids.

More particular examples of suitable protein (or sources thereof) for use in the base powder of the nutritional tablet disclosed herein include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The base powder and, thus, the nutritional tablets described herein may include any individual source of protein or combination of the various sources of protein listed above.

In addition, the protein for use herein can also include, or be entirely or partially replaced by, free amino acids known for use in nutritional products, non-limiting examples of which include L-tryptophan, L-glutamine, L-tyrosine, L-methionine, L-cysteine, taurine, L-arginine, L-carnitine, and combinations thereof.

In certain embodiments, the protein or source of protein consists of only intact or partially hydrolyzed protein; that is, the protein component is substantially free of any protein that has a degree of hydrolysis of 20% or more. In this context, the term “partially hydrolyzed protein” refers to proteins having a degree of hydrolysis of less than 20%, including less than 18%, including less than 15%, including less than 10%, and including proteins having a degree of hydrolysis of less than 5%. In certain embodiments, the protein or source of protein consists of extensively hydrolyzed protein; that is, the protein component is substantially free of any protein that has a degree of hydrolysis of less than 20%. In this context, the term “extensively hydrolyzed protein” refers to proteins having a degree of hydrolysis of at least 20%, including from 20% to 80%, including from 25% to 80%, including from 30% to 75%, and also including proteins having a degree of hydrolysis of 50% to 75%. The degree of hydrolysis is the extent to which peptide bonds are broken by a hydrolysis chemical reaction. To quantify the hydrolyzed protein component of these embodiments, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the Tecator® Kjeldahl method. These analytical methods are well known.

The carbohydrate or source of carbohydrate suitable for use in the base powder of the nutritional tablet disclosed herein may be simple carbohydrates, complex carbohydrates, or variations or combinations thereof. Generally, the carbohydrate may include any carbohydrate or carbohydrate source that is suitable for use in oral nutritional compositions and is otherwise compatible with any other selected ingredients or features of the base powder used to prepare the nutritional tablet.

Non-limiting examples of carbohydrates suitable for use in the base powder of the nutritional tablet described herein include, but are not limited to, polydextrose, maltodextrin; hydrolyzed or modified starch or cornstarch; glucose polymers; corn syrup; corn syrup solids; rice-derived carbohydrate; sucrose; glucose; fructose; lactose; high fructose corn syrup; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low methoxy pectin, high methoxy pectin, cereal beta-glucans (e.g., oat beta-glucan, barley beta-glucan), carrageenan and psyllium, digestion resistant maltodextrin (e.g., Fibersol™, a digestion-resistant maltodextrin, comprising soluble dietary fiber); soluble and insoluble fibers derived from fruits or vegetables; other resistant starches; and combinations thereof. The base powder and, thus, the nutritional tablets described herein may include any individual source of carbohydrate or combination of the various sources of carbohydrate listed above.

The fat or source of fat suitable for use in the base powder of the nutritional tablet described herein may be derived from various sources including, but not limited to, plants, animals, and combinations thereof. Generally, the fat may include any fat or fat source that is suitable for use in oral nutritional compositions and is otherwise compatible with any other selected ingredients or features of the base powder used to prepare the nutritional tablet. Non-limiting examples of suitable fat (or sources thereof) for use in the base powder of the nutritional tablet disclosed herein include coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof. Generally, the fats used for formulating infant formulas and pediatric formulas provide fatty acids needed both as an energy source and for the healthy development of the infant, toddler, or child. Fatty acids provided by the fats in the nutritional tablets include, but are not limited to, capric acid, lauric acid, myristic acid, palmitic acid, palmitoleic acid, stearic acid, oleic acid, linoleic acid, alpha-linolenic acid, arachidonic acid (ARA), eicosapentaenoic acid (EPA), and docosahexanoic acid (DHA). The base powder and, thus, the nutritional tablets described herein can include any individual source of fat or combination of the various sources of fat listed above.

Optional Ingredients

The base powder of the nutritional tablets described herein may further comprise other optional ingredients that may modify the physical, chemical, hedonic, or processing characteristics of the nutritional compositions or serve as additional nutritional components when used for a targeted population. Many such optional ingredients are known or otherwise suitable for use in other nutritional products and may also be used in the base powders described herein, provided that such optional ingredients are safe and effective for oral administration and are compatible with the essential and other ingredients in the base powders described herein.

Non-limiting examples of such optional ingredients include preservatives, antioxidants, emulsifying agents, buffers, additional nutrients as described herein, colorants, flavors, thickening agents, stabilizers, and so forth.

In certain embodiments, the base powder of the nutritional tablets comprise minerals. Non-limiting examples of minerals include, but are not limited to, calcium, phosphorus, magnesium, iron, zinc, manganese, copper, sodium, potassium, molybdenum, chromium, selenium, chloride, and combinations thereof.

In certain embodiments, the base powder of the nutritional tablets comprise vitamins or related nutrients. Non-limiting examples of such vitamins and related nutrients include, but are not limited to, vitamin A; vitamin D; vitamin E; vitamin K; thiamine; riboflavin, pyridoxine; vitamin B12; carotenoids such as lutein, zeaxanthin, astaxanthin, alpha- or beta-cryptoxanthin, beta-carotene, and lycopene; niacin; folic acid; pantothenic acid; biotin; vitamin C; choline; inositol; salts and derivatives thereof and combinations thereof.

The base powder of the nutritional tablets disclosed herein may also include one or more masking agents to reduce or otherwise obscure bitter flavors and after taste. Suitable masking agents include natural and artificial sweeteners, sodium sources such as sodium chloride, and hydrocolloids, such as guar gum, xanthan gum, carrageenan, gellan gum, and combinations thereof. The amount of masking agent in the base powder may vary depending upon the particular masking agent selected, other ingredients in the base powder, and other composition or product target variables. Such amounts, however, will most typically range from at least 0.1% by weight of the base powder, including from 0.15% to 3%, and also including from 0.18% to 2.5% by weight of the base powder.

### Method of Manufacture

The nutritional tablets of the present disclosure are made using a multi-step process. The exemplary process described herein produces nutritional tablets having a hardness of no more than 14 N and a surface polarity of greater than 30.5%. As discussed herein, such nutritional tablets are sturdy enough to withstand packaging and handling without easily breaking or crumbling, and also exhibit excellent dissolution characteristics. The nutritional tablets prepared in accordance with the exemplary methods described herein provide a convenient alternative to nutritional compositions in other forms, such as nutritional powders.

In one exemplary embodiment, a method of manufacturing a nutritional tablet is provided. The method includes dryblending a flow agent into a base powder to form an intermediate powder. The base powder comprises protein, carbohydrate, and fat. The intermediate powder is compressed to form a pre-tablet. The pre-tablet is milled to form a final powder, and the final powder is compressed to form the nutritional tablet. The nutritional tablet comprises 0.15% to 6% by weight of flow agent based on the weight of the nutritional tablet. As mentioned above, the nutritional tablet prepared by the exemplary methods described herein has a hardness of no more than 14 N and a surface polarity of greater than 30.5%.

One step of the exemplary method of manufacturing a nutritional tablet includes dryblending a flow agent into a base powder to form an intermediate powder. As previously discussed, the base powder is a nutritional composition that comprises protein, carbohydrate, and fat, and which may be essentially the same as a commercially available nutritional powder, such as a commercially available powdered infant formula. Typically, the base powder will not have the appropriate flow behavior necessary for processing in tablet-making equipment, such as a tablet press. Accordingly, a flow agent is dryblended with the base powder to produce an intermediate powder that is free flowing and suitable for processing in tablet-making equipment.

Dryblending the flow agent into the base powder to produce the intermediate powder may be accomplished in a variety of ways. For example, the dryblending step may be carried out in a ribbon blender, a paddle blender, a vertical blender, a tumble blender, or other appropriate mixing equipment.

Any of the previously described flow agents and base powders may be used in the exemplary methods of manufacturing a nutritional tablet described herein. In certain embodiments, an amount of flow agent is used such that the nutritional tablet comprises from 0.5% to 6% by weight of flow agent. In certain embodiments, an amount of flow agent is used such that the nutritional tablet comprises from 0.5% to 5% by weight of flow agent, including from 0.5% to 4% by weight of flow agent, including from 0.5% to 2% by weight of flow agent, and also including from 0.5% to 1% by weight of flow agent. In certain other embodiments, an amount of flow agent is used such that the nutritional tablet comprises from 1% to 6% by weight of flow agent, including from 3% to 6% by weight of flow agent, and also including from 5% to 6% by weight of flow agent. In certain of the foregoing embodiments, the flow agent dryblended into the base powder is selected from the group consisting of tricalcium phosphate, fumed silica, lactose, and combinations thereof. In certain of the foregoing embodiments, the flow agent dryblended into the base powder is selected from the group consisting of tricalcium phosphate, fumed silica, agglomerated anhydrous lactose, and combinations thereof. In certain of the foregoing embodiments, the flow agent dryblended into the base powder comprises tricalcium phosphate having an average particle size of no more than 5 μm.

In certain embodiments, when the nutritional tablet is formulated as an infant formula tablet, the base powder includes a protein component in an amount such that the resulting nutritional tablet comprises from 5% to 35% by weight protein, including from 10% to 30%, from 10% to 25%, from 15% to 25%, from 20% to 30%, from 15% to 20%, and also including from 10% to 16% by weight protein. When the nutritional tablet is formulated as an infant formula tablet, the base powder also includes a carbohydrate component in an amount such that the resulting nutritional tablet comprises from 40% to 75% by weight carbohydrate, including from 45% to 75%, from 45% to 70%, from 50% to 70%, from 50% to 65%, from 50% to 60%, from 60% to 75%, from 55% to 65%, and also including from 65% to 70% by weight carbohydrate. When the nutritional tablet is formulated as an infant formula tablet, the base powder also includes a fat component in an amount such that the resulting nutritional tablet comprises from 10% to 40% by weight fat, including from 15% to 40%, from 20% to 35%, from 20% to 30%, from 25% to 35%, and also including from 25% to 30% by weight fat.

In certain embodiments, when the nutritional tablet is formulated as a pediatric formula tablet, i.e., a formula intended for infants, toddlers, and/or children, the base powder includes a protein component in an amount such that the resulting nutritional tablet comprises from 5% to 30% by weight protein, including from 10% to 25%, from 10% to 20%, from 10% to 15%, from 15% to 20%, and also including from 12% to 20% by weight protein. When the nutritional tablet is formulated as a pediatric formula tablet, the base powder also includes a carbohydrate component in an amount such that the resulting nutritional tablet comprises from 40% to 75% by weight carbohydrate, including from 45% to 70%, from 50% to 70%, from 55% to 70%, and also including from 55% to 65% by weight carbohydrate. When the nutritional tablet is formulated as a pediatric formula tablet, the base powder also includes a fat component in an amount such that the resulting nutritional tablet comprises from 10% to 25% by weight fat, including from 12% to 20%, and also including from 15% to 20% by weight fat.

In certain embodiments, when the nutritional tablet is formulated as an adult nutritional product (i.e., adult formula tablet), the base powder includes a protein component in an amount such that the resulting nutritional tablet comprises from 5% to 35% by weight protein, including from 10% to 30%, from 10% to 20%, from 15% to 20%, and including from 20% to 30% by weight protein. When the nutritional tablet is formulated as an adult formula tablet, the base powder also includes a carbohydrate component in an amount such that the resulting nutritional tablet comprises from 40% to 80% by weight carbohydrate, including from 50% to 75%, from 50% to 65%, from 55% to 70%, and also including from 60% to 75% by weight of carbohydrate. When the nutritional tablet is formulated as an adult formula tablet, the base powder also includes a fat component in an amount such that the resulting nutritional tablet comprises from 0.5% to 20% by weight fat, including from 1% to 15%, from 1% to 10%, from 1% to 5%, from 5% to 20%, from 10% to 20%, and also including from 15% to 20% by weight fat.

After the flow agent is dryblended into the base powder to form the intermediate powder, the intermediate powder is compressed to form a pre-tablet. The intermediate powder may be compressed to form the pre-tablet using a conventional tablet press. As a general guideline, a predetermined quantity of the intermediate powder is placed into a die. A punch is lowered into the die to exert pressure on and compress the intermediate powder to form a pre-tablet. The amount of pressure used to compress the intermediate powder to form the pre-tablet can vary widely depending on the die/punch configuration utilized. In certain embodiments, the amount of pressure used to compress the intermediate powder to form the pre-tablet is from 500 psig to 1,000 psig. In certain embodiments, the amount of pressure used to compress the intermediate powder to form the pre-tablet is selected such that the pre-tablet has a hardness of 15 N to 50 N.

Another step of the exemplary method of manufacturing a nutritional tablet includes milling the pre-tablet to form a final powder. The pre-tablet may be milled using conventional milling equipment, such as a FitzMill® comminutor from the Fitzpatrick Company (Elmhurst, Ill.). In certain embodiments, the pre-tablet is milled to form a final powder that has an average particle size of 100 μm to 325 μm. The particle size of the final powder can be achieved with the milling equipment by selecting the appropriate milling rotor speed and screen opening size. In certain embodiments, the milling rotor speed is from 1,000 RPM to 4,500 RPM, including milling rotor speeds of 1,000 RPM, 1,500 RPM, 2,500 RPM, and 4,500 RPM, and the screen opening size is from 0.016 inch to 0.109 inch. In one embodiment, the pre-tablet is milled using a milling rotor speed of 1,500 RPM and a screen opening size of 0.109 inch to form the final powder.

In accordance with the exemplary methods disclosed therein, the final powder is compressed to form the nutritional tablet. The final powder may be compressed to form the nutritional tablet using a conventional tablet press. As a general guideline, a predetermined quantity of the final powder is placed into a die. A punch is lowered into the die to exert pressure on and compress the final powder to form the nutritional tablet. The amount of pressure used to compress the final powder to form the nutritional tablet can vary widely depending on the die/punch configuration utilized. In general, the amount of pressure used to compress the final powder to form the nutritional tablet is selected such that the nutritional tablet has a hardness of no more than 14 N. In certain embodiments, the amount of pressure used to compress the final powder to form the nutritional tablet is from 500 psig to 1,000 psig.

In certain exemplary embodiments, the method of manufacturing the nutritional supplement further comprises dryblending additional flow agent into the final powder prior to compressing the final powder. Thus, in certain embodiments, a portion of the total amount of flow agent is dryblended into the base powder to form the intermediate powder, and the remaining portion of the total amount of flow agent is dryblended into the final powder prior to compressing the final powder to form the nutritional tablet. Dryblending the flow agent into the final powder may be accomplished in a variety of ways. For example, the dryblending may be carried out in a ribbon blender, a paddle blender, a vertical blender, a tumble blender, or other appropriate mixing equipment.

Any of the previously described flow agents may be used for dryblending into the final powder. In certain embodiments, the flow agent that is dryblended into the final powder is selected from the group consisting of tricalcium phosphate, fumed silica, lactose, and combinations thereof.

In certain embodiments, the flow agent dryblended into the base powder comprises tricalcium phosphate having an average particle size of no more than 5 μm, and the flow agent dry blended into the final powder comprises tricalcium phosphate having an average particle size of no more than 5 μm. In certain embodiments, the flow agent dryblended into the base powder comprises tricalcium phosphate having an average particle size of no more than 5 μm, and the flow agent dry blended into the final powder comprises tricalcium phosphate having an average particle size of no more than 5 μm and agglomerated anhydrous lactose.

In certain embodiments, the ratio of the amount of flow agent dryblended into the base powder to the amount of flow agent dryblended into the final powder is from 20:1 to 1:20, including from 10:1 to 1:10, including from 5:1 to 1:5, including from 2:1 to 1:2, and also including a ratio of 1:1. In an exemplary embodiment, the flow agent dryblended into the base powder and the final powder comprises tricalcium phosphate having an average particle size of no more than 5 μm, and the ratio of the amount of flow agent dryblended into the base powder to the amount of flow agent dryblended into the final powder is from 20:1 to 1:20, including from 10:1 to 1:10, including from 5:1 to 1:5, including from 2:1 to 1:2, and also including a ratio of 1:1. In another exemplary embodiment, the flow agent dryblended into the base powder comprises tricalcium phosphate having an average particle size of no more than 5 μm, and the flow agent dry blended into the final powder comprises tricalcium phosphate having an average particle size of no more than 5 μm and agglomerated anhydrous lactose, and the ratio of the amount of flow agent dryblended into the base powder to the amount of flow agent dryblended into the final powder is from 20:1 to 1:20, including from 10:1 to 1:10, including from 5:1 to 1:5, including from 2:1 to 1:2, and also including a ratio of 1:1.

Forming and milling the pre-tablet results in a final powder that has a different particle structure compared to the intermediate powder, which is believed to modify the thermodynamic properties, such as increasing the surface energy and surface polarity, of the nutritional tablet. Furthermore, formulating the nutritional tablet to have a hardness of no more than 14 N, such as 8 N to 14 N, provides enough rigidity to resist crumbling or breaking during handling and packaging, but also promotes dissolution by having a less compact arrangement of the powder particles in the nutritional tablet as well as by having more surface area of the nutritional tablet exposed to the dissolution medium (e.g., water). According to fundamental thermodynamic laws, high surface energy means that interfaces between a solid and air are not favorable. Thus, nutritional tablets with a high surface energy wet well by liquids, such as water, since the liquid wetting eliminates the solid-air interface in favor of a liquid-solid interface, thereby improving dissolution of the nutritional tablet. It was found that, in addition to a high surface energy (e.g., a surface energy of at least 45 mJ/m²), nutritional tablets having a hardness of no more than 14 N and a surface polarity of greater than 30.5% exhibit excellent dissolution, such as at least 85% dissolution.

### Use

The nutritional tablets of the present disclosure provide a convenient alternative to nutritional compositions in other product forms, such as nutritional powders and liquids. The nutritional tablets are easily reconstituted with the addition of a suitable aqueous fluid, typically water, to form a liquid nutritional composition for immediate oral or enteral use. In this context, “immediate” use generally means within about 48 hours, most typically within about 24 hours, preferably right after reconstitution. As previously mentioned, the nutritional tablets may be formulated to provide a single serving of the nutritional composition, which will vary depending on the intended user (e.g., an infant, toddler, child, adult). Alternatively, the nutritional tablets may be formulated to provide multiple (e.g., two, three, four) servings of the nutritional composition. The nutritional tablets may be formulated as infant formula tablets, pediatric formula tablets, or adult formula tablets for use by infants, toddlers, children, and adults as desired or needed.

### Example

The following example illustrates specific exemplary embodiments and features of the nutritional tablets and methods disclosed herein. The example is given solely for the purpose of illustration and is not to be construed as a limitation of the present disclosure, as many variations thereof are possible without departing from the spirit and scope of the disclosure. All exemplified amounts are weight percentages based upon the total weight of the nutritional tablets, unless otherwise specified.

This example illustrates the improvement in nutritional tablet dissolution that is achieved by making nutritional tablets according to the exemplary methods disclosed herein. In this example, two formulations were used to prepare control nutritional tablets (control 1, control 2) and experimental nutritional tablets (experimental 1, experimental 2). The dissolution of the control nutritional tablets (control 1, control 2) were compared to the dissolution of experimental nutritional tablets (experimental 1, experimental 2).

The control 1 nutritional tablets and the experimental 1 nutritional tablets had identical compositions. In particular, the control 1 nutritional tablets and the experimental 1 nutritional tablets were comprised of 99.3% by weight commercially available infant formula powder and 0.7% by weight tricalcium phosphate.

The control 1 nutritional tablets were prepared by dryblending the tricalcium phosphate into the commercially available infant formula powder, and then compressing the resulting powder into the control 1 nutritional tablets.

The experimental 1 nutritional tablets were prepared using the following steps. Half of the tricalcium phosphate (i.e., 0.35% based on total weight of the nutritional tablet) was dryblended into the commercially available infant formula powder to form an intermediate powder. The intermediate powder was compressed to form pre-tablets. The pre-tablets were milled using a FitzMill® comminutor with a milling rotor speed of 1,500 RPM and a screen opening size of 0.109 inch to form the final powder. Next, the remaining tricalcium phosphate (i.e., 0.35% based on total weight of the nutritional tablet) was dryblended into the final powder. Finally, the final powder was compressed into the experimental 1 nutritional tablets.

The control 2 nutritional tablets and the experimental 2 nutritional tablets had identical compositions. In particular, the control 2 nutritional tablets and the experimental 2 nutritional tablets were comprised of 94.3% by weight commercially available infant formula powder, 0.7% by weight tricalcium phosphate, and 5% by weight SuperTab 24AN agglomerated anhydrous lactose.

The control 2 nutritional tablets were prepared by dryblending the tricalcium phosphate and agglomerated anhydrous lactose into the commercially available infant formula powder, and then compressing the resulting powder into the control 2 nutritional tablets.

The experimental 2 nutritional tablets were prepared using the following steps. Half of the tricalcium phosphate (i.e., 0.35% based on total weight of the nutritional tablet) was dryblended into the commercially available infant formula powder to form an intermediate powder. The intermediate powder was compressed to form pre-tablets. The pre-tablets were milled using a FitzMill® comminutor with a milling rotor speed of 1,500 RPM and a screen opening size of 0.109 inch to form the final powder. Next, the remaining tricalcium phosphate (i.e., 0.35% based on total weight of the nutritional tablet) and the agglomerated anhydrous lactose (5% based on total weight of the nutritional tablet) was dryblended into the final powder. Finally, the final powder was compressed into the experimental 2 nutritional tablets.

The various nutritional tablets were tested for physical characteristics such as particle size before final compression, final tablet weight, tablet thickness, tablet hardness, and dissolution, as well as thermodynamic characteristics, such as overall surface energy, polar component of surface energy, dispersive component of surface energy, and surface polarity. The physical characteristic data is provided in Table 3, and the thermodynamic data is provided in Table 4.

The thermodynamic data was generated using the Washburn method and the Fowkes theory. Hexane, diiodomethane, and water were used as the probe liquids to obtain material constants and contact angles via the Washburn method. Application of the Fowkes theory allowed the calculation of overall surface energy, the surface energy components, and the surface polarity of the tablets.

TABLE 3

| | Weight | Thickness | Hardness | Particle | Dissolu- |
|---|---|---|---|---|---|
| | (g) | (mm) | (N) | Size (μm) | tion (%) |
| Control 1 | 6.36 | 10.83 | 18.2 | 296 | 73.29 |
| Experimental 1 | 7.36 | 12.7 | 11.5 | 159 | 88.4 |
| Control 2 | 6.91 | 11.63 | 18.2 | 225 | 77.99 |
| Experimental 2 | 7.17 | 12.52 | 9.7 | 248 | 91.17 |

TABLE 4

| | | Polar | Dispersive | |
|---|---|---|---|---|
| | Overall | Component | Component | |
| | Surface | of Surface | of Surface | Surface |
| | Energy | Energy | Energy | Polarity |
| | (mJ/m²) | (mJ/m²) | (mJ/m²) | (%) |
| Control 1 | 46.47 | 13.54 | 32.93 | 29.13 |
| Experimental 1 | 47.57 | 14.59 | 32.98 | 30.67 |
| Control 2 | 47.01 | 14.08 | 32.93 | 29.95 |
| Experimental 2 | 48.51 | 15.36 | 33.15 | 31.66 |

Notably, even though the control 1 and experimental 1 nutritional tablets were identical from a composition standpoint, and the control 2 and experimental 2 nutritional tablets were identical from a composition standpoint, the data shows that the experimental nutritional tablets exhibited a higher dissolution than their respective control nutritional tablets. In addition, the experimental nutritional tablets had a higher surface energy and surface polarity than their respective control nutritional tablets, but also had a lower hardness than the respective control nutritional tablets.

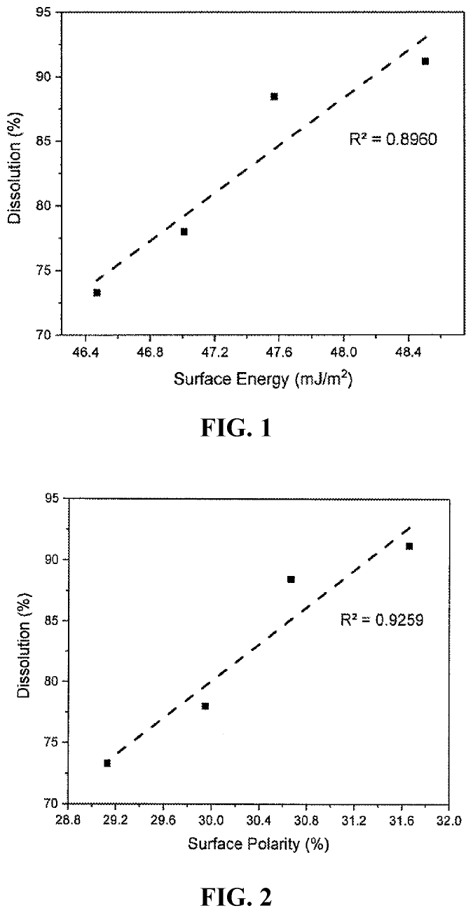

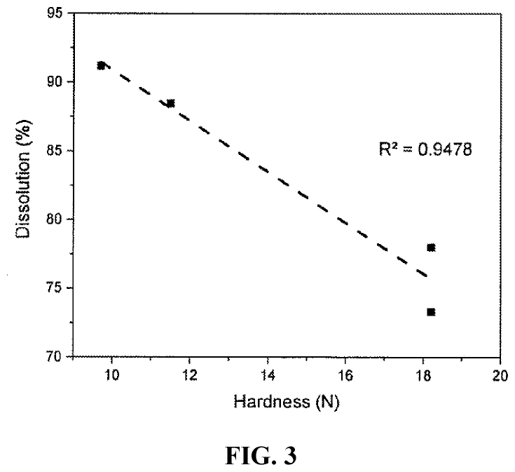

Thus, it can be concluded that the different methods of making the nutritional tablets, in particular the milling step, affects the dissolution properties of the nutritional tablet. Moreover, linear regression analysis of the data shows that nutritional tablets having a higher surface energy (FIG. 1), in particular a higher surface polarity (FIG. 2), as well as a lower hardness (FIG. 3) exhibit better dissolution.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative compositions or formulations, and illustrative examples shown and described. Accordingly, departures may be made from such details without departing from the spirit or scope of the applicant's general disclosure herein.

All percentages, parts, and ratios as used herein are by weight of the total formulation, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein may be used in practice or testing of the nutritional composition. The materials, methods, and examples disclosed herein are illustrative only and not intended to be limiting.

The nutritional tablets and corresponding manufacturing methods of the present disclosure can comprise, consist of, or consist essentially of the essential elements of the disclosure as described herein, as well as any additional or optional element described herein or which is otherwise useful in nutritional tablet applications.

To the extent that the terms “includes,” “including,” “contains,” or “containing” are used in the specification or the claims, they are intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.”

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range. All combinations of method or process steps as used herein can be performed in any order, unless otherwise specified or clearly implied to the contrary by the context in which the referenced combination is made.

The various embodiments of the compositions of the present disclosure may also be substantially free of any optional ingredient or feature described herein, provided that the remaining composition still contains all of the required ingredients or features as described herein. In this context, and unless otherwise specified, the term “substantially free” means that the selected composition contains less than a functional amount of the optional ingredient, typically less than about 1 wt %, including less than about 0.5 wt %, including less than about 0.1 wt %, and also including zero percent, of such optional ingredient, by weight of the composition.

1. A nutritional tablet comprising:
a compressed nutritional powder comprising:
protein;
carbohydrate;
fat; and
0.15% to 6% by weight of a flow agent based on the weight of the nutritional tablet,
wherein the nutritional tablet has a hardness of no more than 14 N and a surface polarity of greater than 30.5%.

2. The nutritional tablet of claim 1, wherein the nutritional tablet has a hardness of 8 N to 12 N.

3. The nutritional tablet of claim 1, wherein the nutritional tablet has a hardness of 8 N to 10 N.

4. The nutritional tablet of claim 1, wherein the nutritional tablet comprises from 0.5% to 6% by weight of the flow agent based on the weight of the nutritional tablet.

5. The nutritional tablet of claim 1, wherein the flow agent is selected from the group consisting of tricalcium phosphate, fumed silica, lactose, and combinations thereof.

6. The nutritional tablet of claim 1, wherein the flow agent comprises tricalcium phosphate having an average particle size of no more than 5 μm.

7. The nutritional tablet of claim 6, wherein the flow agent further comprises agglomerated anhydrous lactose.

8. The nutritional tablet of claim 1, wherein the nutritional tablet comprises protein in an amount of 5% to 35% by weight of the nutritional tablet.

9. The nutritional tablet of claim 1, wherein the nutritional tablet comprises carbohydrate in an amount of 40% to 75% by weight of the nutritional tablet.

10. The nutritional tablet of claim 1, wherein the nutritional tablet comprises fat in an amount of 10% to 40% by weight of the nutritional tablet.

11. A method of manufacturing a nutritional tablet, the method comprising:
dryblending a flow agent into a base powder to form an intermediate powder, the base powder comprising protein, carbohydrate, and fat;
compressing the intermediate powder to form a pre-tablet;
milling the pre-tablet to form a final powder; and
compressing the final powder to form the nutritional tablet;
wherein the nutritional tablet comprises 0.15% to 6% by weight of flow agent based on the weight of the nutritional tablet; and
wherein the nutritional tablet has a hardness of no more than 14 N and a surface polarity of greater than 30.5%.

12. The method of claim 11, further comprising dryblending additional flow agent into the final powder prior to compressing the final powder.

13. The method of claim 11, wherein the nutritional tablet has a hardness of 8 N to 12 N.

14. The method of claim 11, wherein the nutritional tablet has a hardness of 8 N to 10 N.

15. The method of claim 11, wherein the nutritional tablet comprises from 0.5% to 6% by weight of flow agent based on the weight of the nutritional tablet.

16. The method of claim 11, wherein the flow agent is selected from the group consisting of tricalcium phosphate, fumed silica, lactose, and combinations thereof.

17. The method of claim 11, wherein the flow agent dryblended into the base powder comprises tricalcium phosphate having an average particle size of no more than 5 μm, and the flow agent dry blended into the final powder comprises tricalcium phosphate having an average particle size of no more than 5 μm.

18. The method of claim 11, wherein the flow agent dryblended into the base powder comprises tricalcium phosphate having an average particle size of no more than 5 μm, and the flow agent dry blended into the final powder comprises tricalcium phosphate having an average particle size of no more than 5 μm and agglomerated anhydrous lactose.

19. The method of claim 11, wherein the nutritional tablet comprises protein in an amount of 5% to 35% by weight of the nutritional tablet, carbohydrate in an amount of 40% to 75% by weight of the nutritional tablet, and fat in an amount of 10% to 40% by weight of the nutritional tablet.

20.-21. (canceled)

22. The nutritional tablet of claim 1, wherein the nutritional tablet is an infant formula tablet.

23. (canceled)
